(19) United States
(12) Patent Application Publication
(10) Pub. No.: US 2008/0229014 A1
(43) Pub. Date: Sep. 18, 2008

(54) Disk Interface Card

(76) Inventor: Kwok-Yan Leung, Willowdale (CA)

Correspondence Address: LIN & ASSOCIATES INTELLECTUAL PROPERTY, INC., P.O. BOX 2339, SARATOGA, CA, 95070-0339, US

(21) Appl. No.: 11/685,752

(22) Filed: Mar. 13, 2007

(51) Int. Cl. G06F 13/00

(52) U.S. Cl. 711/115

(57) ABSTRACT

A disk interface card includes a disk interface, a cache memory, a bus interface and a microprocessor. The disk interface card is electrically connected to a host disk interface of a host through a cable. The disk interface card can be cooperated with a conventional disk array card, which is able to connect with several hard drives, so as to form an external hard drive array. The external hard drive array can be connected to the host through the cable. The disk interface card passively uses the cache memory to store an access command from the host, and waits for the disk array card to come to read out the access command therefrom.

### BACKGROUND OF THE INVENTION

1. Field of the Invention

The present invention generally relates to a disk interface card, and in particular to a disk interface card that can be cooperated with a disk array card to form an external storage device.

2. The Prior Arts

Recently, the performance of CPU and GDI (graphics device interface) has been increasingly improved. Due to the reason that the performance of a disk system is hardly improved, the disk system gradually becomes a bottleneck of the whole system performance. Despite the attempt to improve the disk technology, the specification of the disk system still cannot enhance the capability of the disk subsystem.

There has been an obvious advancement on the performance of the disk system since the RAID (Redundant Array of Inexpensive Drive) was developed. The RAID technology combines more than two physical hard drives into a single logical unit, which can provide with a function of data integrity and fault-tolerance, so as to entirely increase the capability of the disk subsystem. The RAID technologies are typically used on high performance workstation or server, which are SCSI RAID construction. Currently, because the performance of the IDE hard drive is rapidly enhanced, the IDE RAID technology has become mature.

Different RAID levels can meet with customers' demands on availability, performance and capacity of the storage system. The most commonly used RAID levels include NRAID, JBOD, RAID 0, RAID 1, RAID 0+1, RAID 3 and RAID 5. In consideration of the enhancement of the reliability and performance, RAID 5 and RAID 0+1 are typically chosen.

To allow users to share the RAID technology, the users just need to buy a disk array card and install it on the computer, particularly on the motherboard, and install proper driver according to different operation system.

In a case that a computer system installed with the disk array card is required to share the storage capability of its disk array, the low-speed network connection or the cable connection is alternatively used, which needs extra procedures of setting and installing the aforesaid network and cable connection and has a problem on data delivery.

Although an external hard drive array has been in the market, the price is very expensive, not so cheap as an internal disk array card. However the disk array card requires high setup technique. If the cheaper disk array card can be utilized to implement the function similar to the external hard drive array, there will be a big demand on it.

### SUMMARY OF THE INVENTION

A primary objective of the present invention is to provide a disk interface card, which comprises a disk interface, a cache memory, a bus interface and a microprocessor, and is electrically connected to a host disk interface of a host through a cable. The disk interface card can be cooperated with a conventional disk array card, which is able to connect with several hard drives, so as to form an external hard drive array. The external hard drive array can be connected to the host through the cable. The disk interface card passively uses the cache memory to store an access command from the host, and waits for the disk array card to come to read out the access command therefrom.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram showing a disk interface card in accordance with the present invention; and

FIG. 2 is a schematic diagram showing the installation of the disk interface card in accordance with the present invention.

### DETAILED DESCRIPTION OF THE PREFERRED EMBODIMENT

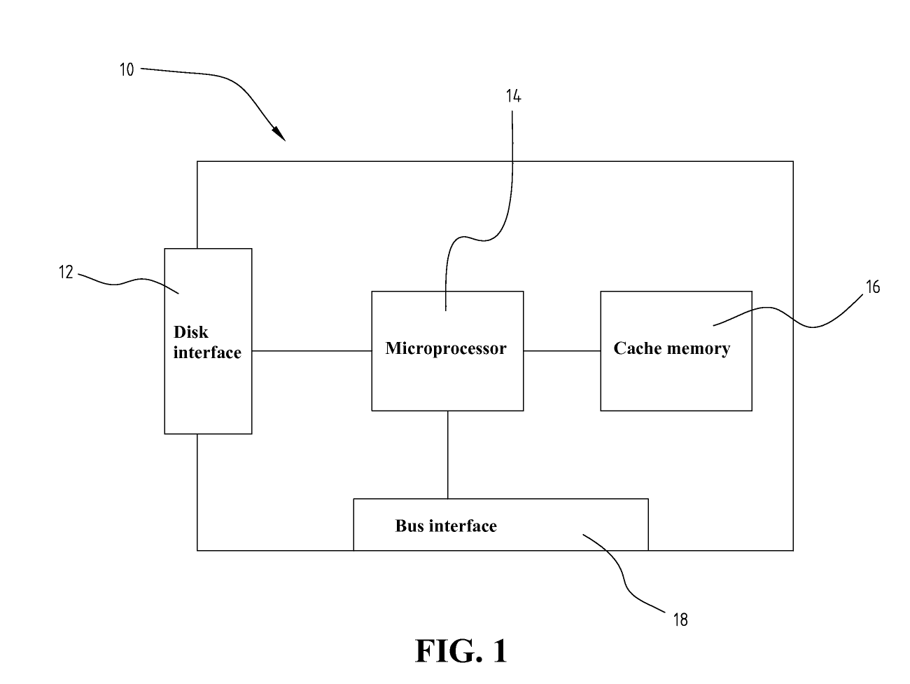

With reference to FIG. 1, a disk interface card 10 in accordance with the present invention comprises a disk interface 12, a cache memory 16, a bus interface 18, and a microprocessor 14. Although the disk interface card 10 of the present invention is similar to the most PCI cards, the disk interface 12 of the disk interface card 10, such as VGA, is very special.

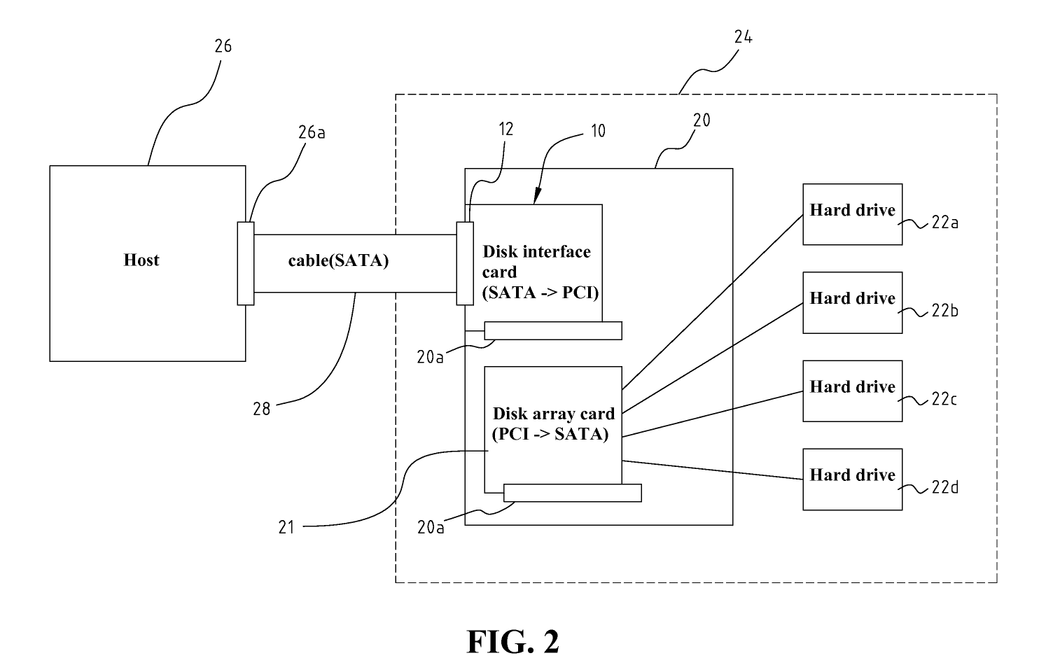

The bus interface 18 of the disk interface card 10 and a disk array card 21 (see FIG. 2) can be electrically connected with each other using PCI, ISA, EISA or LPC. The disk interface 12 may be a Small Computer System Interface (SCSI), a Fiber Channel Interface (FC), a Serial Storage Architecture (SSA), an Integrated Drive Electronics (IDE), a Universal Serial Bus (USB), an IEEE 1394, a Personal Computer Memory Card International Association (PCMCIA), a Serial ATA (SATA), and a Parallel ATA (PATA).

The disk interface card 10 of the present invention may be regarded as a SATA-to-PCI card, while the conventional disk array card 21 may be simply regarded as a PCI-to-Multiport (such as SATA) card. The disk interface card 10 can be cooperated with the disk array card 21 so as to form an external hard drive array.

Referring to FIG. 2, in order to enable to coordinately operate the disk interface card 10 and the disk array card 21, the two cards 10, 21 have to be respectively inserted into slots (such as PCI slots) 20a and 20b of a motherboard 20, and meanwhile the disk array card 21 connects with hard drives 22a-22d according to the conventional manner. The combination of the motherboard 20 with the disk interface card 10 and the disk array card 21, in which the hard drives 22a-22d are connected with the disk array card 21, forms a virtual hard drive 24 having a disk interface 12, such as SATA interface.

The motherboard 20 is slightly modified to allow a host 26 to access data from the hard drives 22a-22d. Actually, the disk interface card 10 is a bridge component between the host 26 and the hard drives 22a-22d (or the disk array card 21).

A cable 28 is utilized to connect a host disk interface 26a of the host 26 with the disk interface 12 of the disk interface card 10, so that the disk interface card 10 can receive an access command (such as read data from the hard drives 22a-22d) from the host 26 through the cable 28.

Since the disk interface card 10 cannot work as a CPU to send the received access command to the disk array card 21, the access command has to be temporarily stored in the cache memory 16 until the disk array card 21 comes to read out it therefrom.

When the disk array card 21 reads out the access command, the corresponding handling processes will be performed according to the RAID-related technologies. After finishing the handling processes, if a response to be sent to the host 26 or a data delivery to the host 26 is required, that has to be delivered to the disk interface card 10 through the disk array card 21 under the control of the microprocessor 14 of the disk interface card 10.

The foregoing detailed description of the preferred embodiment is used to further understand the feature and sprit of the present invention, not to limit the scope of the present invention. It should be appreciated that there are many modifications and substitutions without departing from the spirit and the scope of the present invention which is defined by the appended claims.

What is claimed is:

1. A disk interface card, comprising
a disk interface coupled with a cable for electrically connection with a host disk interface of a host through the cable;
a cache memory for temporarily storing an access command from the host;
a bus interface, electrically connected to a motherboard; and
a microprocessor for processing and controlling the access command and a data delivery between the motherboard and the host.

2. The disk interface card as claimed in claim 1, wherein the motherboard is electrically connected with a disk array card that is able to connect with a plurality of hard drives.

3. The disk interface card as claimed in claim 2, wherein when the motherboard reads out the access command from the cache memory, the disk array card starts to access data of the hard drives according to the access command.

4. The disk interface card as claimed in claim 2, wherein the bus interface of the disk interface card and the disk array card are electrically connected with each other using one of PCI, ISA, EISA and LPC.

5. The disk interface card as claimed in claim 1, wherein the disk interface is one of a Small Computer System Interface (SCSI), a Fiber Channel Interface (FC), a Serial Storage Architecture (SSA), an Integrated Drive Electronics (IDE), a Universal Serial Bus (USB), an IEEE 1394, a Personal Computer Memory Card International Association (PCMCIA), a Serial ATA (SATA), and a Parallel ATA (PATA).
